(19) United States
(12) Patent Application Publication
(10) Pub. No.: US 2026/0228053 A1
(43) Pub. Date: Aug. 6, 2026

(54) FRAMEWORK FOR HIERARCHICALLY ALLOCATING RESOURCES AND MONITORING RESOURCE USAGE OF CLOUD DATABASE RUNTIME ENTITIES

(71) Applicant: Oracle International Corporation, Redwood Shores, CA (US)

(72) Inventors: Vijayendra Rao Lakkundi, Hyderabad (IN); Sue-Kyoung Lee, Emerald Hills, CA (US); Joseph Francis Therrattil Koonen, Bangalore (IN)

(73) Assignee: Oracle International Corporation, Redwood Shores, CA (US)

(21) Appl. No.: 19/042,717

(22) Filed: Jan. 31, 2025

(51) Int. Cl. G06F 9/50; G06F 16/23

(52) U.S. Cl. CPC G06F 9/505; G06F 16/2358

(57) ABSTRACT

A computer program product, system, and computer implemented method for a framework for hierarchically allocating resources and monitoring resource usage of cloud database runtime entities. The approach leverages control groups mechanisms provided by underlying operating systems for managing resource allocations to processes and collecting metrics using control groups at a granularity that is conducive to efficient operation and management of modern database systems such as consolidated databases (CDBs). In some embodiments, the present approach provides the ability to manage the isolation of resource between groups by enforcing separation between resource such as cores, memory regions, and the like. Another way in which the present approach can improve management of CDB instances is by allowing for the database to manage creation of additional groups (e.g., consumer groups) that can be used to aggregate the usage that is attributable to respective groups to provide visibility to clients and to database administrators alike.

### BACKGROUND

Modern computing systems handle large amounts of data and users. For single user/device data storage systems this often corresponds to gigabytes and even terabytes of data. However, in the context of network environments, such as in a cluster, where multiple users or services are provided, the amount of data to be managed is often in the order of petabytes of data, or more, some of which may be shared by multiple users or used to provide services to multiple users. Unfortunately, the systems designed for individual users simply are not capable of efficiently handling the amount of data and users in these network environments.

One current approach to address the needs of network systems is to use pluggable databases such as in a consolidated database. This solves the problem of data management to a certain extent by allowing different pluggable databases to be open as needed in a consolidated database instance and even allows multiple users/services to operate on that data concurrently by allowing the same pluggable database to be open in multiple consolidated database instances at the same time. However, the use of consolidated databases presents another challenge in managing those consolidated databases.

Specifically, such large and complex systems still need to be managed appropriately. One facet of this is the management of the allocation of resources to different processes that execute workloads on behalf of respective users. Likewise, monitoring the consumption of resources, e.g., in the context of the allocation thereon, is desirable for database users to be able to tailor the services that they purchase to the actual load which they place on those services. Likewise, accurately monitoring the consumption of resources can help improve the utilization of those resources and scheduling of tasks that use those resources.

Therefore, there is a need for an improved approach to allocating resources and monitoring resource usage of cloud database runtime entities.

### SUMMARY

Embodiments of the present disclosure provide a method, apparatus, and product for a framework for hierarchically allocating resources and monitoring resource usage of cloud database runtime entities.

The approaches disclosed herein leverage the control groups mechanisms provided be underlying operating systems. For example, Linux based operating systems normally provide a mechanism for managing resources allocation to processes and collecting corresponding metrics using control groups. However, such existing mechanisms do not have the necessary granularity to manage the allocations necessary for modern database systems such as consolidated databases (CDBs). The present approach provides for one or more consolidated database instances that access and update corresponding control groups to manage the allocation and monitoring of resources in a more granular level then can be achieved with existing control group processes. In this way the control groups functionality can be extended to suit the needs of consolidated database instances while simplifying database management and reducing a number of processes needed to monitor use of resources by CDB instances and customers thereof. Furthermore, the approaches provided herein are not limited to Linux cgroups. Instead, the present approaches are applicable to other allocation, monitoring, isolation artefacts provided by vendors and operating systems. For example, the approaches provided herein can also be used with the Intel resource control (resctrl) interface and may be used for at least memory and cache allocation and monitoring. Likewise, the present approaches are also applicable to Intel Resource Director Technology (Intel(R) RDT) and AMD Platform Quality of Service (AMD QoS). In fact, the present approaches are vendor agnostic as it can be edited to account for any vendor exposed resource allocation and monitoring mechanisms.

Additional benefits to the present approach include the ability to manage the isolation of resource between groups (e.g., clients, users, departments, or any other definable group) by control which resources are allocated to which groups and enforcing separation between resource such as cores, memory regions, and the like. Another way in which the present approach can improve the management of CDB instances is by allowing for the database to manage creation of additional groups (e.g., consumer groups) that can be used to aggregate the usage that is attributable to a group of users (e.g., a client department or other grouping thereof) to provide visibility to clients and to database administrators alike. Such groups may be controlled in a dynamic matter and can change as different resource types become available.

Further details of aspects, objects and advantages of the disclosure are described below in the detailed description, drawings, and claims. Both the foregoing general description and the following detailed description are exemplary and explanatory and are not intended to be limiting as to the scope of the disclosure.

### BRIEF DESCRIPTION OF THE DRAWINGS

The drawings illustrate the design and utility of embodiments of the present disclosure, in which similar elements are referred to by common reference numerals. To better appreciate the advantages and objects of embodiments of the disclosure, reference should be made to the accompanying drawings. However, the drawings depict only certain embodiments of the disclosure, and should not be taken as limiting the scope of the disclosure. The drawings use like reference numerals to identify like elements, and unless otherwise specified, any description for that element may be applicable to each use of that reference numeral were appropriate.

FIG. 1 illustrates an example system in which some embodiments of the disclosure are implemented.

FIG. 2 illustrates a flow for a framework for hierarchically allocating resources and monitoring resource usage of cloud database runtime entities according to some embodiments.

FIG. 3 illustrates a flow for capturing a CDB instance configuration in a control group according to some embodiments.

FIG. 4 illustrates a flow for processing configuration change events based on at least hierarchical CDB metrics in corresponding control groups according to some embodiments.

FIG. 5 illustrates an example hierarchy for control groups which may include consumer groups according to some embodiments.

FIG. 6 illustrates an example system in which some embodiments of the disclosure are implemented.

FIG. 7 illustrates a flow for validating a configuration change prior to assignment or adjustment of resources to a corresponding control group according to some embodiments.

FIG. 8 illustrates a flow for assigning and adjusting resources and limits for a configuration change using a corresponding control group according to some embodiments.

FIG. 9A-9D provide an example flow for processing a configuration change event comprising a PDB open operation according to some embodiments.

FIG. 10A-10B provide an example flow for processing a configuration change event comprising a PDB close operation according to some embodiments.

FIG. 11 is a diagram of a computing system suitable for implementing an embodiment of the present disclosure.

FIG. 12 is a block diagram of one or more components of a system environment in which services may be offered as cloud services, in accordance with an embodiment of the present invention.

### DETAILED DESCRIPTION OF THE EMBODIMENTS OF THE DISCLOSURE

Various embodiments are described hereinafter with reference to the figures. It should be noted that the figures are not necessarily drawn to scale. It should also be noted that the figures are only intended to facilitate the description of the embodiment(s) and are not intended as an exhaustive description of the disclosure or as a limitation on the scope of the disclosure. In addition, an illustrated embodiment need not have all the aspects or advantages shown. An aspect or an advantage described in conjunction with a particular embodiment is not necessarily limited to that embodiment and can be practiced in any other embodiments even if not so illustrated. Additionally, as provided herein, unless otherwise indicated, the description of items identified by the same reference number are applicable to all instances of that item unless otherwise indicated herein.

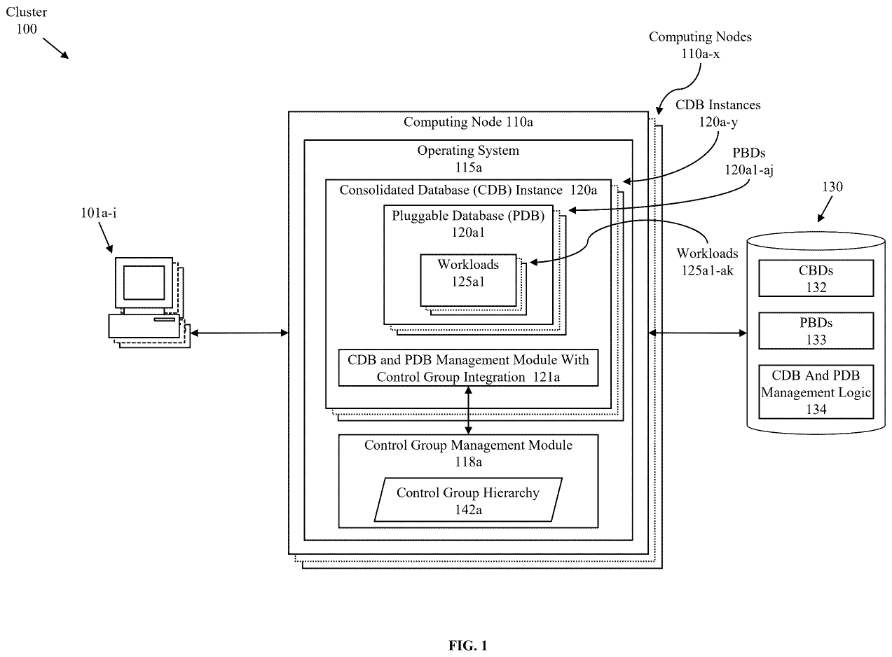

FIG. 1 illustrates an example system in which some embodiments of the disclosure are implemented. Generally, the system includes one or more computing nodes that can each include one or more consolidated database (CDB) instances which in turn include one or more pluggable databases (PDBs) that may be open in the consolidated database instance at any given time. Each CDB instance may further include one or more workloads that may be executed or are executing on the CDB instance. Additionally, each CDB might have a number of PDBs that are open, and each open PDB can have any number of sessions or workloads (e.g., calls and acts which may in turn generate further calls and acts and so on) that access a corresponding PDB. Furthermore, a CDB instance may include a process that interacts with a control group mechanism of an underlying operating system to manage the allocation of resources and to cause the collection of usage metrics thereof by the control group mechanism.

The system comprises a cluster 100 that includes computing nodes 110a-x and a database 130. Each computing node 110a-x might comprise one or more consolidated database instances—such as consolidated databases 120a-y as illustrated for computing node 110a with operating system 115a—which might in turn have one or more pluggable databases (PDBs) open at any given time (see e.g., 120a1-aj). Each PDB may also have one or more workloads for a respective PDB (see e.g., 125a1-ak) which may or may not be nested workloads or a combination thereof. In some embodiments, a computing node has multiple operating systems installed (e.g., using a hypervisor) where each may be used for any appropriate purpose such as to host one or more CDB instances which may also practice the approaches provided herein.

The computing devices 101a-i interact with consolidated database (CDB) instance(s) on respective nodes of the computing nodes 110a-x (e.g., 120a on computing node 110a) to interface with one or more computing nodes (see e.g., 110a-x) for initiation of workloads on respective PDBs—e.g., using one or more sessions. Furthermore, the computing devices might be controlled by a user, another service, an administrator, or comprise any other computing device that allows for data access or management of a CDB and PDB or an element therein. Any CDB instance can be associated with multiple PDBs and each CDB instance may have one or more open PDBs at any given time, where the PDBs that are open on one CDB instance may or may not overlap with PDBs open in another CDB instance. A PDB itself is essentially a set of metadata and data where the metadata describes a schema, schema objects, and nonschema objects that can be presented on a network as a separate database. In some embodiments, one or more of the consolidated database instances (e.g., 120a1) comprise a container database or a collection of containers. In some embodiments, one or more of the PDBs comprise containers (e.g., partitions or virtual disks), which may be defined by a class, data structure, or an abstract data type. In some embodiments, the PDBs may comprise a container equivalent.

The computing devices 101a-i comprise any type of computing device that may be used to operate or interface with the CDB instance or open PDB therein, whether directly or indirectly. Examples of such user computing devices 101 include workstations, personal computers, laptop computers, or remote computing terminals. User computing devices 101 may also comprise any type of portable tablet device, including for example, tablet computers, and portable readers. User computing devices 101a-i may also include any mobile device that can suitably access any computing systems on the Internet such as smartphones and mobile handsets. It is noted that the disclosure is not limited in its application to just these types of devices. The embodiments of the disclosure are applicable to any computing device that works in conjunction with access to digital information stored on, as an example, the Internet. One of ordinary skill in the art may appreciate that embodiments of this present disclosure may be implemented on the Internet, on a closed network, on a hybrid open and closed network, or on a cloud network.

In some embodiments, an operating system (see e,g., 115a) includes a control group management module (see 118a) that manages a control group management hierarchy (142a). In some embodiments, the control group management module includes one or more processes for collecting metrics for processes identified in the control groups in a hierarchical manner. For instance, the control group management module might be included in an operating system (e.g., a Linux operating system) where the control groups (cgroups) provide a mechanism for capturing both allocations of resources at different levels and measurement of the use of those resources. For example, control groups or cgroups generally comprises a collection of processes for implementing resource limits such as memory, caching, I/O bandwidth, CPU limits, etc., which are managed using the control group management module 118a and are represented by a control group hierarchy (see e.g., control group hierarchy 142a) which is organized as a hierarchical collection of folders where each folder corresponds to a cgroup and specifies the allocations of resources and/or limits on resource consumption and the relevant utilization data for the corresponding workloads represented in the cgroup as is known in the art. Generally, when a CDB instance is allocated, resources of the operating system may be allocated to the CDB instance by the control group management module 118a. However, without more, the control group management module cannot specifically control the allocation of resources that are already allocated to the CDB instance to workloads therein in a hierarchical manner (let alone in a way that is consistent with policies that may be embodied in a consolidated database such as in the CDB and PDB management logic 134)—e.g., the allocation of resources by the control group management module cannot separately divide the resources allocated to the CDB instance to workloads therein at a finer level of detail. Furthermore, CDB instances are normally managed in a dynamic fashion to control the allocation of resource in a manner that is consistent with a set of rules which may be customer specific or may vary by customer—e.g., according to one of a set of service levels. Simply put, the control group management modules that are included with operating systems (e.g., Linux operating systems) lack the necessary information to manage the allocation of resources to workloads of the CDB instance or PDBs therein in a manner that is well suited to a service provided to any number of customers which may have different service level requirements. For example, if the CDB instance is allocated 4 processor cores and 128 GBs of memory and includes 3 open PDBs each with multiple workloads, the control group management module cannot specifically manage how resources are apportioned to each PDB instance and to each workload therein and instead simply allow each PDB instance to attempt to consume as much of the CDB instance resources as they can. Additionally, in some embodiments, additional groupings (consumer groups) are provided that are specifically directed towards customer management and monitoring, where workloads can be placed into one or a plurality of consumer groups that can also be organized into and with a hierarchical arrangement. For instance, consumer groups might comprise backup workloads, SQL workloads, file access workloads, workloads segregated by department, service or any other designation or grouping.

As provided herein, the present application discusses approaches for a framework for hierarchically allocating resources and monitoring resource usage of cloud database runtime entities largely in the context of Linux cgroups for ease of explanation. However, the approaches provided herein are not limited to Linux cgroups. Instead, the present approaches are applicable to other allocation, monitoring, isolation artefacts provided by vendors and operating systems. For example, the approaches provided herein can also be used with the Intel resource control (resctrl) interface and may be used for at least memory and cache allocation and monitoring. Likewise, the present approaches are also applicable to Intel Resource Director Technology (Intel(R) RDT) and AMD Platform Quality of Service (AMD QoS). In fact, the present approaches are vendor agnostic as it can be edited to account for any vendor exposed resource allocation and monitoring mechanisms.

In some embodiments, the CDB and PDB management module 121a includes a control group integration module to provide for more fine grain control of the allocation and consumption monitoring of resources by processes therein. This will be discussed further throughout this application. Briefly, the CDB and PDB management module 121a can access the database 130 to retrieve CDB and PDB management logic (see e.g., 134) to determine how to allocate resources of the CDB instance to the relevant workloads and where to place those workloads in the hierarchy of the control groups. For example, when a new workload is being instantiated, the CDB and PDB management module 121a may access the CDB and PDB management logic to determine how the workload should be classified, to place the workload in a corresponding control group based on that classification, and to provide an allocation of resources to the workload from the resources available to the corresponding control group. In some embodiments, this include adjusting the allocations of resources in the corresponding control group and potentially in any subgroups by traversing the control group structure and making any indicated adjustments to the control group allocations. As provided herein, workloads and processes are used interchangeably. Additionally, each workload may include any number of nested workloads (sub-workloads), each of which may be independently allocated resources and monitored using a combination of the CDB and PDB management module 121a and the control group management module 118a. In some embodiments, each CDB instance may be associated with one or more workloads to maintain the consolidated database (e.g., background maintenance processes and foreground user service/listening processes) and to enable access thereof. As provided herein, a workload comprises any process or collection of processes. For example, the CDB instance is a workload that comprises a collection of other workloads such as workloads to manage the CDB instance, workloads to manage the creations of PDBs, opening PDBs, closing PDBs, and any processes that execute against any of those resources whether for foreground tasks (e.g., tasks that operate to service requests from an accessing entity (e.g., a user)) or background task (e.g., tasks that operate to manage the CBD instance, PDBs, Sessions, etc. (e.g., system maintenance tasks)).

In some embodiments, the database 130 includes CDBs (132) and the corresponding PDBs (133). Generally, a consolidated database is a database that consolidates or is used to consolidate data from multiple sources. Such a database may be to centralize the access, storage, or a combination thereof of data from various sources. Furthermore, the data from the multiple sources may be included in one or more PDB in a one-to-one arrangement or a many to one arrangement.

Additionally, as illustrated here, database 130 includes CBD/PDB management logic 134. As will be discussed herein, CBD/PDB management logic includes logic to manage the execution of workloads to provide access to one or more PDBs via a CDB. Briefly, this generally includes logic to determine classifications of workloads, minimum allocations of resources and how to allocate those resources. In some embodiments, the CBD/PDB management logic represents multiple different permutations for determining minimum allocations of resources and how to allocate those resources for clients, or respective users of a set of users associated with a client, using client specific logic or by placing users into different service levels.

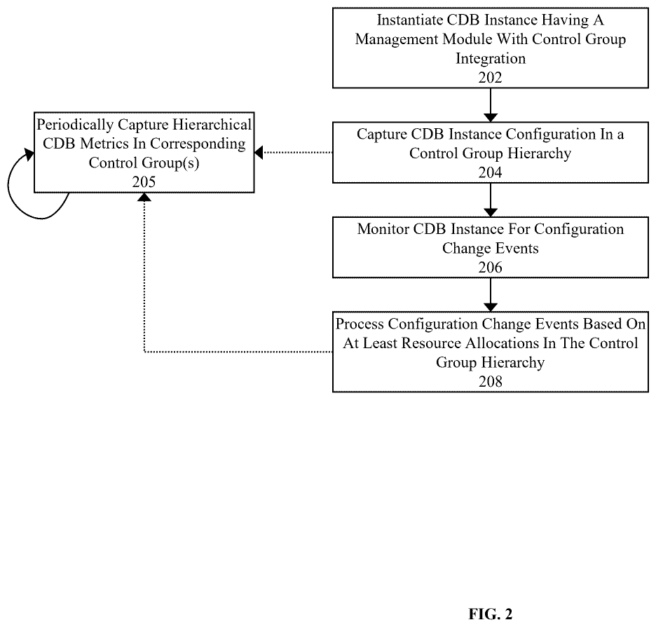

FIG. 2 illustrates a flow for a framework for hierarchically allocating resources and monitoring resource usage of cloud database runtime entities according to some embodiments. Generally, the approach includes instantiating a CDB instance with a set of resources using the control group mechanism. Subsequently, as workloads are initiated or requested, resources are allocated to those workloads, which may include placement of those workloads into corresponding control groups and allocating resources from the resources allocated to those control groups.

The process generally starts at 202 where a CDB instance is instantiated and includes a management module with control group integration. For example, a CDB instance might be instantiated by executing an executable file. In some embodiments, resources are allocated to the CDB instance from an underlying operating system upon which the CDB instance executes. Furthermore, at 204 the configuration of resources allocated to the CDB instance may be captured at 204. Such an allocation could be based on an initial request corresponding to the execution of the CDB instance, a request by the CDB instance based on the application of the CDB and PDB management logic, a calculate by the CDB using the CDB and PDB management logic based on at least the available resources of the operating system, or some combination thereof. For instance, an initial allocation might comprise a default or minimum allocation of resources to the CDB instance. A subsequent allocation might be determined based on the application of the CDB and PDB management logic to the resources of the operating system. In some embodiments, an underlying operating system may include multiple CDB instances where the resources of the underlying operating system are shared as indicated by application of the CDB and PDB management logic (see e.g., 134). Regardless of how the allocation is determined, that allocation is written into the control group hierarchy at 204. For example, the CDB and PDB management module (see e.g., 121a) might issue an instruction to the control group management module (see e.g., 118a) to write the corresponding allocations into the control group hierarchy (see e.g., 142a), or might directly write the allocations into the control group hierarchy (see e.g., 142a). In some embodiments, the CDB instance also includes one or more workloads. For example, the CDB instance may include workloads for monitoring for requests to create PDBs, to open PDBs, to close PDBs, and to perform maintenance or configuration tasks for the CDB instance (e.g., to log activity, collect status information, perform data hygiene tasks etc.). Such CDB workloads may be segregated using different control groups by the CDB instance via the CDB and PDB management module.

At 205, metrics are captured for control groups at the different levels of the hierarchy. Specifically, the mechanisms that implements the control group (e.g., part of a Linux operating system) periodically capture metrics for members of each control group at each level of the hierarchy. Such metrics generally comprise point in time values that are captured at regular/periodic intervals. These values are written into the control group hierarchy for later use such as for monitoring consumption of resources at any level of said hierarchy and for use in making allocation adjustments. Thus, once a workload has been identified in the control group hierarchy, that workload is then subject to the control of the operating system (e.g., to limit resource consumption beyond what is allocated) and to collect resource consumption information.

After the CDB instance has been instantiated and allocated a set of resources via the control group mechanism, the process continues at 206 where the CDB instance is monitored for configuration change events. Such an approach will be discussed further herein. Briefly, a configuration change event corresponds to the start, or end, of a workload. For example, any time a PDB is to be created, opened, or closed is a new workload. Similarly, any time a new session is to be open, a call, act, or other request is started, or a process for the CDB instance is triggered, such activity is, or is represented as, a configuration change event. Such events need to be processed to determine how to allocate resources and from where as represented in the control group hierarchy those resources are to be allocated.

At 208, the configuration change events are processed based on at least resource allocations in the control group hierarchy. Briefly, processing may include determining a corresponding location in the control group hierarchy for allocation of resources, determining whether there are sufficient resources to service the event, when possible allocating resources to the workload by updating the corresponding control group(s) in the control group hierarchy, and potentially updating the resources allocated to already existing workloads when indicated by the corresponding allocation logic. In some embodiments, determining whether there are sufficient resources to service the event comprises determining whether there are sufficient resources to be distributed between the existing workloads and the new workload(s) corresponding to the configuration change event such that no minimum resource allocation requirements are violated (see e.g., CDB and PDB management logic 134). Finally, once a workload is placed in the control group hierarchy the operating system manages any allocation of resources and metrics collection as discussed above in regard to 205.

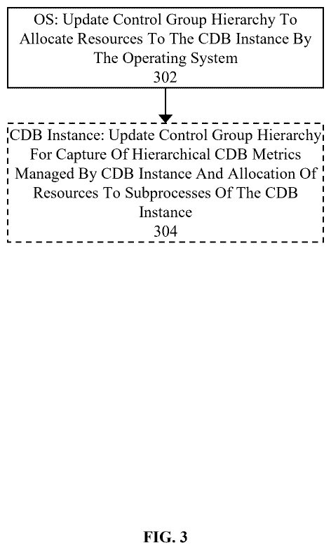

FIG. 3 illustrates a flow for capturing a CDB instance configuration in a control group according to some embodiments. Generally, the approach may be implemented by two different processes e.g., the operating system upon which the CDB instance is to execute and the CDB instance itself.

For example, an initial allocation might be provided by an operating system upon which the CDB instance is to be instantiated at 302. Specifically, when a request to start a CDB instance is received, the operating system may allocate a minimum or requested amount of resources to that CDB instance. Those resources could comprise any resources for which the control group hierarchy is usable to manage and monitor—e.g., a number of central processing units, individual cores, individual threads, volatile memory such as random access memory, cache whether volatile or nonvolatile, IOPs, network bandwidth, etc. Such allocations would be to the process for the CBD instance and may be inherited by any subprocesses of the CDB instance. In some embodiments, those allocations are represented in the operating system by creating a directory and one or more corresponding files that specify the parameters of the resource allocation in a corresponding control group—e.g., a control group management module creates one or more entries or files in a control group hierarchy (see e.g., 118a and 142a).

In some embodiments, at 304, the CDB instance may update the control group structure to provide a finer grain allocation and for finer grain monitoring of resource consumption by creating one or more subgroups and allocations thereof which may be arranged in a hierarchical manner. For example, the CDB instance may create a first subgroup in the control group hierarchy for foreground tasks (e.g., monitoring for user requests and processing those requests) and a second subgroup in the control group hierarchy for background tasks (e.g., for management and maintenance of the CDB—e.g., logging, backups, archiving, etc.). Such allocations may be based on corresponding CDB and PDB management logic (see e.g., 134). Generally, the groupings created by the CDB instance of CDB workloads can be managed according to the CDB and PDB management logic in any of the ways provided herein—e.g., by classifying, grouping, and allocating resources. In some embodiments, this includes creating a reservation or allocating resources to current or future PDB workloads.

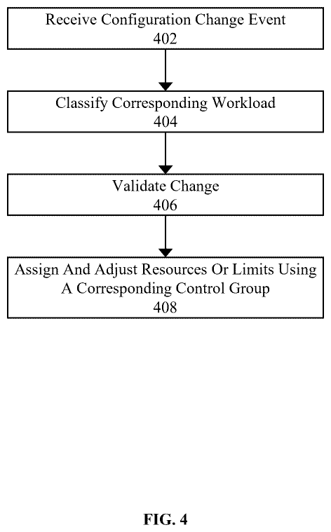

FIG. 4 illustrates a flow for processing configuration change events based on at least hierarchical CDB metrics in corresponding control groups according to some embodiments. Generally, the flow is executed by a CBD and PDB management module with control group integration and includes an initial receipt of a configuration change event, classification of a workload corresponding to the configuration change event, validating the workload to determine if the any necessary changes can be effectuated, and assigning and adjusting resources or limits of any corresponding control groups.

The process is initiated based on receipt of the configuration change event at 402. For example, the CDB instance may include a process (e.g., corresponding to 206) to monitor the CDB instance to detect requests corresponding to new workloads (e.g., creating a PDB, opening a PDB, closing a PDB, starting a new session, or requesting an action in an existing session). Such requests maybe be packages into or transferred as a configuration change event and received at 402. For example, a first portion of a CDB and PDB management module with control group integration may detect a corresponding request and transfer that request to a second portion of the CDB and PDB management module that receives the configuration change event at 402. In some embodiments, the configuration change events may also comprise events from the CDB instance for foreground or background tasks.

At 404, in response to the receipt of the configuration change event, a classification process is executed to determine how to classify a workload associated with the configuration change event. For instance, a subset of the CDB and PDB management logic is applied to one or more parameters of the configuration change event to determine relevant information such as a source of the request, a corresponding customer and/or user for the requests, a type of the request (e.g., an operation to create a PDB, open a PDB, close a PDB, a request in an existing or new session, etc.). Such information is then used to determine a corresponding classification of the workload corresponding to the request. In some embodiments, a configuration change event may correspond to multiple workloads which may or may not be nested and may or may not be processed individually or as a whole.

At 406 the configuration change event is validated to determine whether the workload can be accommodated. For instance, the classification is used to determine the lowest level location in the control group hierarchy where resource allocations for the corresponding workload would be inserted. Once identified, information representing the current allocations for any existing workloads already in the control group hierarchy at that location is retrieved. Subsequently, a set of logic is applied to determine whether resources can be allocated to the corresponding workload without causing the corresponding workload or any of the existing workloads to violate a minimum allocation—e.g., whether there is a way to allocate or reapportion the resources allocated to workloads that does not violate any minimum allocation requirements for those workloads. If the minimum allocations can be satisfied at the lowest level, each group in a higher level may be processed in a recursive manner to verify that the configuration change event would not violate a minimum allocation requirement at any subsequent group or level further up the hierarchy. If any minimum allocation requirement is violated, at any level, the workload request may be rejected either permanently or for a period of time (e.g., the request may be placed on a first in first out queue where workloads are subsequently allocated resources as those resource become available). In some embodiments, before rejecting a workload corresponding to a configuration change event, the process further analyzes the control group hierarchy and the resources of the operating system to determine whether additional resources can be allocated to the corresponding lowest control group, either directly or indirectly, to accommodate the workload.

Presuming it is determined at 406 that the workload corresponding to the configuration change event does not violate a minimum allocation requirement, the process proceeds to 408 where resource allocations and/or limits are assigned and adjusted. For instance, the CDB and PDB management logic is accessed and the relevant parameters and logic for both the existing workloads in the control group and the workload corresponding to the configuration change event are retrieved and processed using the relevant parameters. Allocations of resources or limits is then made based on those calculations. The process then continues in a recursive manner as necessary for each control group in a higher level of the control group hierarch. In some embodiments, the set of logic used to validate a workload and to assign and adjust resources or limits overlap in that information from the validation process may be used to speed up the assign and adjust resources or limits at 408.

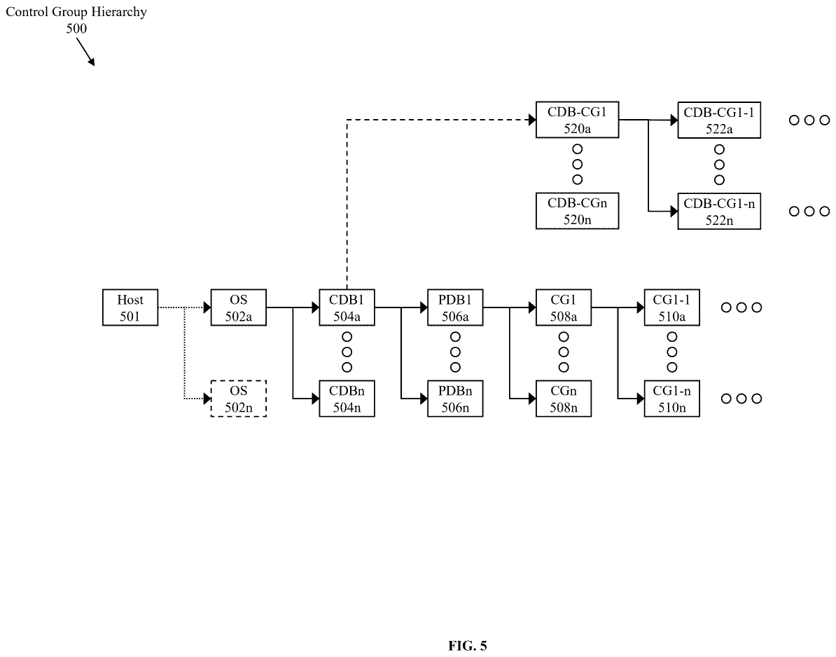

FIG. 5 illustrates an example control group hierarchy which may include consumer groups according to some embodiments. Generally, the control group hierarchy illustrated here is only one example of a control group hierarchy that may be implemented. This is because the CDB and PDB management logic can determine how the control group hierarchy is structured for workloads of and within a CDB instance. Thus, there can be any combination of hierarchical elements. The illustration provided here is only one potential embodiment of that control group hierarchy.

In some embodiments, a host 501 may include one or more operating systems. For instance, a single operating system could be placed on the host and all the resources of the host could be exposed to the single operating system for consumption. In some embodiments, multiple operating systems could be supported by a single host using virtualization (e.g., a hypervisor) to present only a subset of the resources of the host to each of the operating systems. In some embodiments, the control group hierarchy starts at the level of the operating system. For instance, a root or lowest level of the control group hierarchy represents the resources of the operating system (see e.g., 502a-n)—e.g., the entire set of resources that can be used by the operating system or the processes therein. In some embodiments, the resources of the operating system are represented separately from the control group hierarchy.

In some embodiments, multiple operating system can each include a separate control group hierarchy. For instance, host 501 comprises a set of resources that can be allocated to an operating system (see e.g., 502a). As illustrated here, the operating system (see e.g., 502a) includes a control group hierarchy which may be thought of as a collection of parent child relationships, where all the children of the parent may be able to make use of some or all of the resources of the parent, but not more than the resources of the corresponding parent. Likewise, each child may be a parent to any number of children which can then make use of some or all of the resources of their immediate parent. Functionally, this can be organized into folders with subfolders where each folder further includes information that specifies the resource allocations or limits to each corresponding item therein. Generally, control groups and their corresponding allocations or limits are applied to processes. However, each process may spawn any number of sub-processes which may be managed using the control group hierarchy—e.g., as part of the process that spawned the process or as a child of the process that spawned the sub-process.

The control group hierarchy 500 illustrated here illustrates one approach to arrange the control group hierarchy. In the illustrated example, an operating system (see e.g., 502a) may include one or more subprocesses comprising CDB instances (see e.g., CDB1-CDBn identified as 504a-n). Each CDB instance may also be associated with any number of open PDBs (see e.g., PDB1-PDBn identified as 506a-n). Likewise, each PDB may be associated with one or more consumer groups (see e.g., CG1-CGn identified as 508a-n) which may in turn have one or more sub-consumer groups (see e.g., CG1-1 through CG1-n identified as 510a-n) and so on. As provided herein consumer groups are an organizational mechanism that can be used to manage workloads in a control group for resource allocation and resource utilization metric collection. Additionally, each CDB instance might also be associated with one or more consumer groups (see e.g., CDB-CG1 through CDB-CGn identified as 520a-n) which may in turn have one or more sub-consumer groups (see e.g., CDB-CG1-1 through CDB-CG1-n identified as 522a-n).

In some embodiments, CDB or PDB instances may be within or a child of a consumer group. For example, a customer might require that a CDB instance be allocated only to that customer to avoid sharing the CDB instance for any reason (e.g., security). In such a case, the CDB instance might be placed within a consumer group in the control group hierarchy and allocated resources from the consumer group. Additionally, subgroups inherit at least a subset of the resources of the consumer group. In some embodiments, different PDB instances might be placed into one or more consumer groups. For instance, multiple consumer groups might be provided as subgroups of a CDB instance, and each of those consumer groups might be used to manage resource allocation and metrics collection of all of the PDBs from only a single customer. In some embodiments, the PDBs may be placed into one or more consumer groups based on the division specified by a customer—e.g., PDBs (or subsets thereof) for HR, engineering, and accounting might be managed separately. In some embodiments, control groups may be interspersed with other groups. For example, a CDB instance that is allocated to only one customer might be placed within a consumer group or above a consumer group. Likewise, PDBs for different customers, departments, or other groups, might be placed relatively speaking within different consumer groups. This allows for a customer to view metrics information at different levels within associated with the CDB instance, to help guide decisions on allocation of resources and selection of what resources to purchase (e.g., whether to subscribe to a bronze, silver, or gold tier service with a corresponding service level agreement). In this way, the control group management mechanism provided by an operating system can be integrated with the processes of CDB instances to monitor and manage resource allocation and consumption thereof.

In some embodiments, the control group hierarchy can also be used to enforce isolation between processes. For instance, a CPU or core might be allocated to a single CDB instance or customer. Likewise, a different memory range might be allocated to different customers. Similarly, bandwidth (e.g., network bandwidth) might be allocated to different customers. Other embodiments or even mixed embodiments, could be provided. For instance, allocations could be based on which service level agreements are applicable to individual customers where a higher tier customer might be provided a with a greater reservation of resources than a lower tier customer—e.g., PDBs of a gold level customer might be allocated more resources than PDBs of bronze or silver level customers.

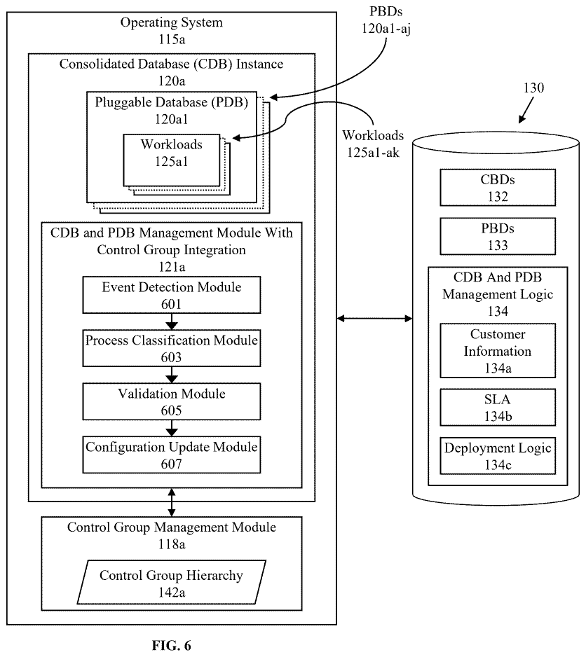

FIG. 6 illustrates an example system in which some embodiments of the disclosure are implemented. FIG. 6 is similar to FIG. 1 but includes at least an expanded embodiment of the operating system of FIG. 1. As provided herein, the discussion and description of like identified elements from FIG. 1 are also applicable to FIG. 6 except where the description herein contradicts the description of FIG. 1.

FIG. 6 differs from FIG. 1 with regard to the CDB and PDB management module with control group integration 121a and the CDB and PDB management logic 134. Additionally, for ease of understand, FIG. 6 illustrates only a single instance of an operating system with a single CDB instance though the embodiment of FIGS. 1 and 6 could be combined in any way. Likewise, solely for ease of understanding, FIG. 6 also omits the computing devices 101a-i.

The CDB and PDB management module with control group integration 121a as illustrated here includes an event detection module 601, a process classification module 603, a validation module 605, and a configuration update module 607. These modules interact to detect and process configuration change events. For example, the event detection module 601 monitors a corresponding CDB instance to detect configuration change events that corresponded to a new or changed workload. Upon detection a corresponding configuration change event is transferred to the process classification module. A process classification module 603 processes to the configuration change event to determine how to classify a corresponding workload so that a corresponding workload can be mapped to a corresponding control group. The process classification module then sends the configuration change event and the workload classification to a validation module. A validation module 605 processes the configuration change event to determine whether there are sufficient resources to execute the corresponding workload based on at least a corresponding portion of a control group hierarchy (see e.g., 142a) and the CDB and PDB management logic (see e.g., 134). Generally, this comprises applying a set of logic to determine whether the corresponding control groups includes an allocation of resources that is sufficient to meet at least minimum allocation of resources for each workload therein if the corresponding workload is added to the group. In some embodiments, the validation process is used to recursively process one or more subgroups (e.g., when resources for that subgroup might change as a result of the allocation. If the validation module 605 successfully validates the configuration change event, it is passed to the configuration update module 607 to update allocation(s) of resources to the corresponding group and to any subgroups in a recursive manner. Specifically, the configuration update module 607 applies at least a subset of logic from the CDB and PDB management logic 134 to update resource allocations or limits for one or more workload represented in each group and reclusively processes each subgroup in a hierarchical manner when a change in allocation occurs.

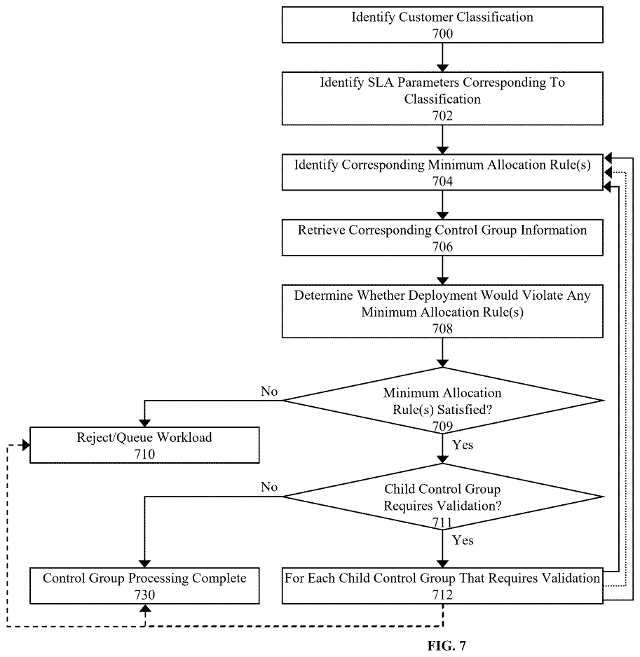

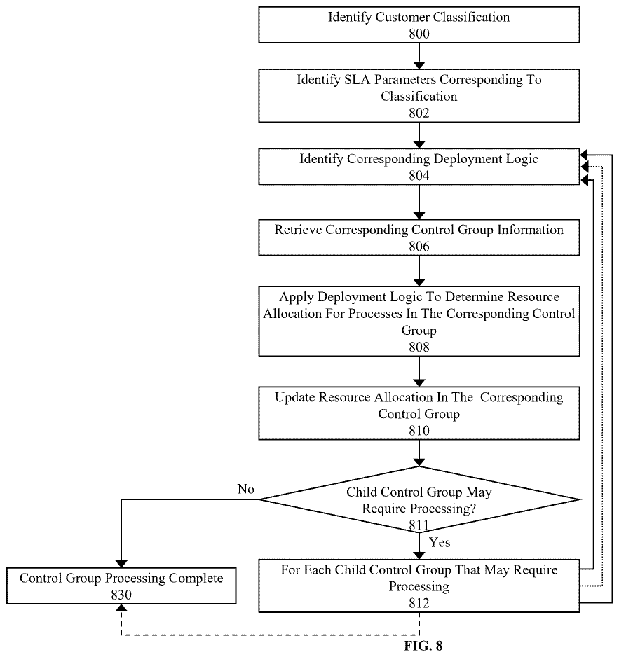

The CDB and PDB management logic 134 as illustrated here has at least three components. The first component is the customer information 134a which can be used to identify relevant information for a customer corresponding to a configuration change event. For example, the customer information may specify any custom logic that is to be applied for the customer with regard to resource allocations and limits, a corresponding service level or plan, or any other relevant information. The customer information may also be mappable to a service level agreement (SLA) 134b, such as a bronze, silver, or gold tier. Generally, a service level agreement defines a service to be provided (e.g., CDB and PDB services) and the level of performance to be expected. In some embodiments, an SLA specifies a minimum reservation of resources for different processes. In some embodiments, an SLA specifies processing time for request based on one or more parameters, database uptime or any other relevant information such as metrics used to determine whether the SLA is being met and remedies when an SLA is not met. The SLA may be mappable to a set or subset of the deployment logic 134c. For example, the multiple different SLAs could be provided (e.g., bronze, silver, and gold) where each maps to a subset of the deployment logic 134c. The deployment logic or the parameters therein may depend on any one or more of a customer's custom logic, the corresponding service level, plan, or SLA. For example, a customer is associated with a service level (e.g., silver) that is mapped to a corresponding set of parameters and logic in a service level agreement (SLA) for the silver tier, which are in turn mapped to one or more rules in the deployment logic that can be used to at least manage allocation of resources to workloads for the customer. The CDB and PDB management module accesses corresponding portions of the CDB and PDB management logic to process configuration change events. In some embodiments, a customer can change their corresponding SLA at any time. In some embodiments, the deployment logic may be dynamically updated based on a change from an administrator or management entity for the CBD or based on an identification of a failure to meet one or more terms of a corresponding SLA—e.g., a database may be monitored using corresponding metrics from one or more control groups to determine whether a current allocation of resources is insufficient to provide the corresponding SLA (within a given threshold). Additional details are provided according to some embodiments in regard to FIGS. 7 and 8.

FIG. 7 illustrates a flow for validating a configuration change prior to assignment or adjustment of resources to a corresponding control group according to some embodiments. Generally, the validation flow determines at least the minimum requirements for each workload in a corresponding level of the control group hierarchy and then recursively processes any higher level (child) control groups to determine whether there are sufficient resources to allocate to the workloads therein, where the minimum requirements are not violated for the any of the workloads in any of the corresponding control groups. FIG. 7 generally applies to an arrangement where the customer classification information is used to determine an SLA agreement that governs the minimum allocation of resources.

In some embodiments, the process starts after the workload has been classified. However, in some embodiments the workload may be classified during the validation process. At 700 customer information is identified. For example, a user or customer identifier associated with the resource or source of the request is used to lookup the customer information. That information might specify the SLA to which the customer is subscribed. In some embodiments, the SLA to which the customer is subscribed is used to retrieve one or more parameters for the SLA. In this way, the customer information (see e.g., 134a) is accessed to determine what service level agreement governs the corresponding workload (e.g., the configuration change event).

Once the SLA that is associated with the user is identified, that information may be used to lookup SLA parameters at 702 corresponding to a classification of the workload. For example, the SLA parameters may specify parameters corresponding to CPU, memory, cache, and bandwidth allocations. In some embodiments, there are multiple different sets of parameters that each correspond to different tiers of service. For instance, a first set corresponds to a bronze tier, a second to a silver tier, and a third to a gold tier. Additionally, each set of parameters may have multiple different subsets each corresponding to different locations in the control group hierarchy.

At 704, any corresponding minimum allocation rules for the corresponding control group hierarchy are identified. Such rules may depend one or more of the SLA parameters and any existing allocations. In some embodiments, there are multiple minimum allocation rules where each corresponds to a resource and an SLA or service tier. Generally, the minimum allocation rules are retrieved for the corresponding control group-e.g., the classification of the workloads can be used to determine which control group the workload should be placed in and the corresponding minimum allocation rules can be determined based on the corresponding SLA as represented by the SLA parameters.

At 706, the corresponding control group information is retrieved. For example, the CDB and PDB management module accesses the control group hierarchy to retrieve information representing the corresponding control group—e.g., the corresponding processes represented therein and the allocations already provided to those processes. Once that information has been retrieved, the minimum allocation rules can be applied at 708 to the processes represented in the corresponding control group to determine whether deploying the corresponding workload would violate any minimum allocation rules for the currently control group. For instance, for each process and resource already represented in the corresponding control group, relevant SLA parameters and minimum allocation rules are used to analyze the workloads in the corresponding control groups and determine the minimum allocation of each resource to each process therein. Likewise, the minimum allocation of resources required for the workload corresponding to the configuration change event is also determined. Those minimum allocations of each resource are then added together—e.g., to form a total minimum allocation of each resource (e.g., CPU, memory, cache, and bandwidth) for the corresponding control group. In some embodiments, one or more processes within the corresponding control group are each associated with an SLA which may be the same SLA or a different SLA. As a result, the rules that are relevant to the determination of a minimum allocation of resources to one process might be different from those for another process, which may result in different minimum allocation requirements for different processes. In some embodiments, a minimum allocation for each process in a control group is stored in that control group for quicker processing. In some embodiments, each process in a control group is associated with a reference or identification of a corresponding minimum allocation rule, one or more parameters for determine the corresponding minimum allocation, or a combination thereof.

At 709, if any of the sums of the minimum resource requirements, determined at 708, exceed the sum of the available resources allocated to the control group, the process determines that the minimum allocation rules are not satisfied. However, if none of the minimum allocation rules are violated (e.g., the total available resources of each type are greater than or equal to the total minimum allocation of each resource) the process determines at 709 that the minimum allocation rules are satisfied. In some embodiments, each control group corresponds to a single SLA agreement or service tier. In some embodiments, processes within a single control group may correspond to multiple different SLAs—where a minimum allocation rule or SLA parameter for one process may be different from another process.

In some embodiments, when it is determined that the minimum allocation rule(s) are not satisfied, the process proceeds to 710 where the workload (or configuration change request) is queue for later reissuance or rejected due to resource limitations. In some embodiments, the process further comprises attempting to allocate additional resources to the corresponding control group. For instance, an additional processor core or memory might be allocated to the CDB instance which is then inherited (at least in part) to a corresponding control group to increase the resources allocated), after which the configuration change event may be re-evaluated to determine whether the corresponding workload can be deployed.

At 711, the process determines whether there are any child control groups that require validation. For instance, if the results of any of the minimum allocation rules and the current allocations are different, the allocation of resources to the new workload associated with the configuration change event might result in a decrease of resources to an existing workload. In such a case, any of the children that might be affected by such a change in allocation of resources will also require validation. Thus, at 712, for each child control group that requires validation a recursive call is made to validate such a change to that child control group. Such recursive calls may be processed as discussed above in regard to 704, 706, 708, 709, 710, 711, 712, and 730. Additionally, in the even that a child control group requires validation, the process may proceed from 712 to 730 after all recursive calls have reported success. However, if any of the child control groups report or return an indication that the workload could not be validated, the process is killed and the workload is rejected or queued at 710. In some embodiments, a reason for rejection is returned on logged. For instance, a log entry is created that identifies the corresponding control group or groups that could not be validated at 710.

FIG. 8 illustrates a flow for assigning and adjusting resources and limits for a configuration change using a corresponding control group according to some embodiments. Generally, the process is similar to that for validating a configuration change prior to assignment or adjustment of resources to a corresponding control group according to some embodiments. However, instead of applying rules to determine whether the minimum allocations can be satisfied the process applies rules to set the actual allocation of resources and setting of limits.

In some embodiment, the process starts after the workload has been classified and validated. Generally, this is because of the hierarchical nature of the control groups and the allocation of resources to those control groups. For example, a control group comprising ten user sessions with each user session having been allocated 10% of the memory available to that control group and each session having a minimum memory allocation of 1 GB. When that control group is allocated at least 10 GB of memory none of the sessions will be in violation of that minimum memory allocation. Additionally, if there is more than 10 GB of memory available, those sessions can benefit from the added memory in a proportional manner. However, if an additional process such as a PDB process is opened in a parent control group, that additional process may siphon off some of the resources allocated to the sessions control group. If that leaves less than the minimum amount of memory for each process a violation of an SLA has occurred. This is avoided by executing the validation process. Assuming then that the validation process was successful, the workload can be executed after the corresponding location in the control group hierarchy is updated to allocate resources to the new process and potentially to adjust allocations to the existing processes.

In some embodiments, at 800 and 802, the customer classification and the SLA parameters corresponding to the classification are retrieved as discussed above in regard to 700 and 702. In some embodiments, the customer classification and the SLA parameters are passed from a validation module to a configuration update module. In some embodiments, the customer classification passed from a validation module is used to identify SLA parameter for processing deployment logic at 802. For example, the SLA parameters may specify parameters corresponding to CPU, memory, cache, and bandwidth allocations. In some embodiments, there are multiple different sets of parameters that each correspond to different tiers of service. For instance, a first set corresponds to a bronze tier, a second to a silver tier, and a third to a gold tier. Additionally, each set of parameters may have multiple different subsets each corresponding to different locations in the control group hierarchy.

At 804, corresponding deployment logic is identified. Such logic may depend one or more of the SLA parameters and any existing allocations. In some embodiments, there are multiple different sets of deployment logic where each corresponds to a resource and an SLA or service tier. Generally, the deployment logic is retrieved for the corresponding control group e.g., the classification of the workloads can be used to determine which control group the workload should be placed in and the corresponding allocation rules.

At 704, any corresponding deployment logic for the corresponding control group hierarchy is identified. The deployment logic may depend one or more of the SLA parameters and any existing allocations. In some embodiments, there are multiple different allocation rules within the deployment logic where each corresponds to a resource and an SLA or service tier. Generally, the allocation rules are retrieved for the corresponding control group-e.g., the classification of the workloads can be used to determine which control group the workload should be placed in and the corresponding allocation rules can be determined based on the corresponding SLA as represented by the SLA parameters.

At 806, the corresponding control group information is retrieved. For example, the CDB and PDB management module accesses the control group hierarchy to retrieve the information representing the corresponding control group—e.g., the corresponding processes represented therein and the allocations already provided to those processes. Once that information has been retrieved, the allocation rules can be applied at 808 to the processes represented in the corresponding control group to determine allocations of resource and limits on resource consumption for each workload in the control group. For instance, for each process and resource already represented in the corresponding control group and the process to be added to the corresponding control group, the relevant SLA parameters and allocation rules are used to analyze the workloads in the corresponding control groups and determine an allocation of each resource to each process therein, which may or may not be the same as the current allocation. Likewise, to the extent that the allocation rules do not account for the minimum allocation requirements for each process, minimum allocations are determined and allocations are adjusted as necessary to meet the minimum requirements for each process—e.g., by representing the allocations as a system of equations and finding a solution that does not violate any minimum allocation rules. In some embodiments, one or more processes within the corresponding control group are each associated with an SLA which may be the same SLA or a different SLA. As a result, the logic that are relevant to the determination of an allocation of resources to one process might be different from those for another process, which may result in different allocations for different processes within the same control group. In some embodiments, allocation rules for each process in a control group is stored in that control group for quicker processing. In some embodiments, each process in a control group is associated with a reference or identification of a corresponding allocation rule, one or more parameters for determine the corresponding minimum allocation, or a combination thereof. In some embodiments, the control group information is passed from a validation module to a configuration update module or cached in a volatile memory of the CBD instance.

Once the allocations of resource and limits on resource consumption are determined, the process proceed to 810 where they are written into the control group. In some embodiments, the CDB and PDB management module with control group integrations writes the corresponding changes into the hierarchy by creating new allocations and groups or updating existing allocations. For example, for the workload being added to the control group, one or more files and folders are written to the control group hierarchy at the corresponding location. However, for existing workloads such files and folders already exist. Thus, instead of creating new files and folders, only the relevant files that corresponding to different allocations need to be modified. In some embodiments, the changes are effectuated by transmitting one or more messages to a control group management module to request that the changes be made.

At 811, the process determines whether there are any child control groups that may require processing. For instance, if the operations to allocate resources or adjust limits changed any of the allocations for an existing process, the allocation of resources and limits on resource consumption of the children (subprocesses) of the existing process might need to be updated. Thus, at 812, for each child control group, for each process that had its allocation or limits changed a recursive call is made to update the allocation of resources and limits on resource consumption. Such recursive calls may be processed as discussed above in regard to 804, 806, 808, 809, 810, 811, 812, and 830. Additionally, in the even that a child control group requires processing, the process may proceed from 812 to 830 after all recursive calls have reported success.

In some embodiments, the processes of FIG. 7 and FIG. 8 may be combined into a single flow. For instance, 704 and 804 may be combined to retrieve both the minimum allocation rules and actual allocation rules. similarly, at 706 and 806 the control group information can be retrieved for application of both sets of rules. Subsequently, 708, 709, and 710 would then be implemented followed by 808 is the validation passed for the corresponding control group. However, instead of updating the resources allocations at 810, the resource allocations and modifications thereof would be stored in a temporary storage element (e.g., a list, linked list, queue, or other structure). After which at 711 and 811 the determination would be made as to whether a child control group requires validation or processing based on the presence or absence of actual expected modifications to applied to the current control group. The merged flow would then proceed to 712 and 812 where each child control group is recursively processed. Finally, is no minimum allocation rule violations are detected the process would apply the resource allocations and modifications thereof stored in the temporary storage element at 830.

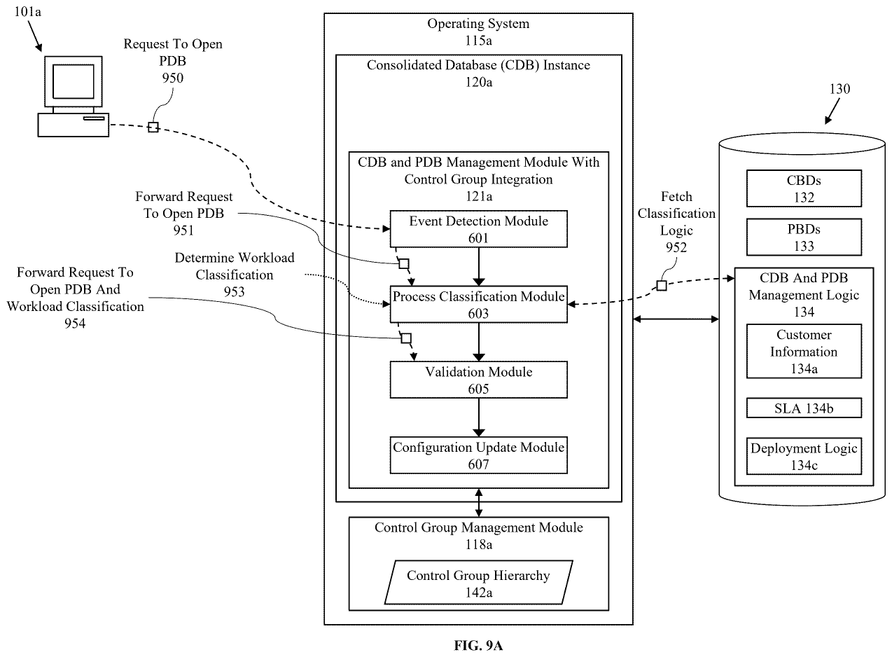

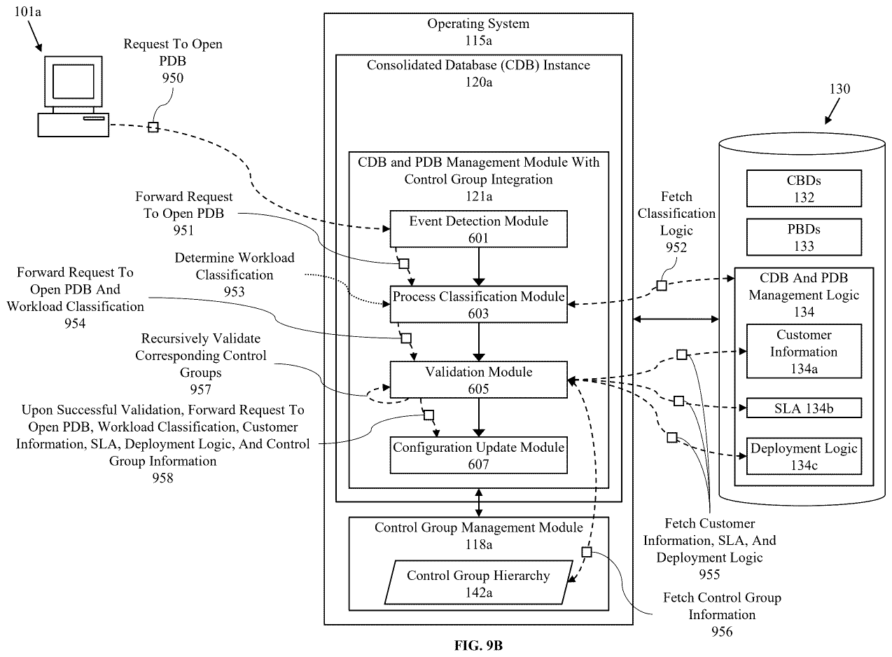

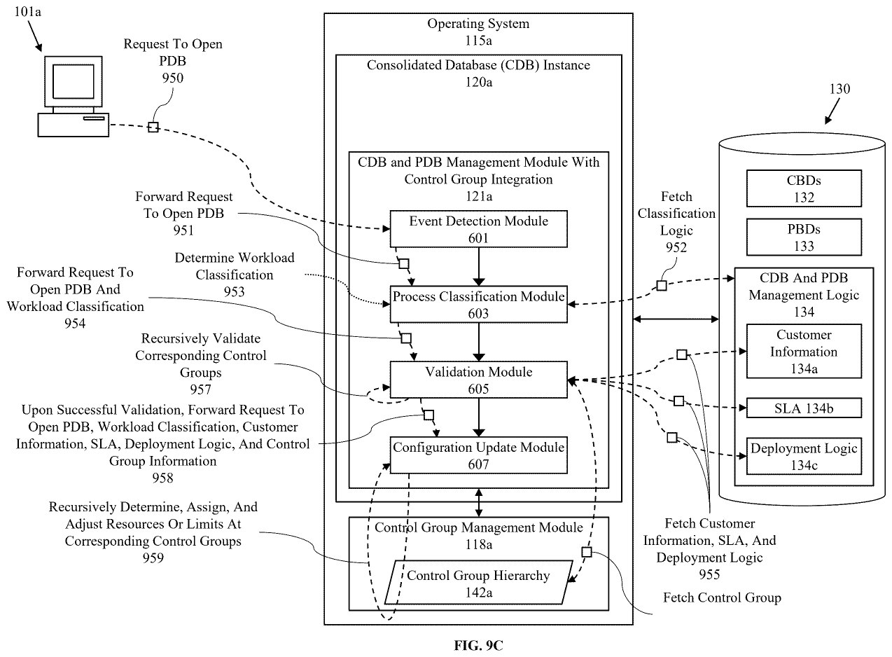

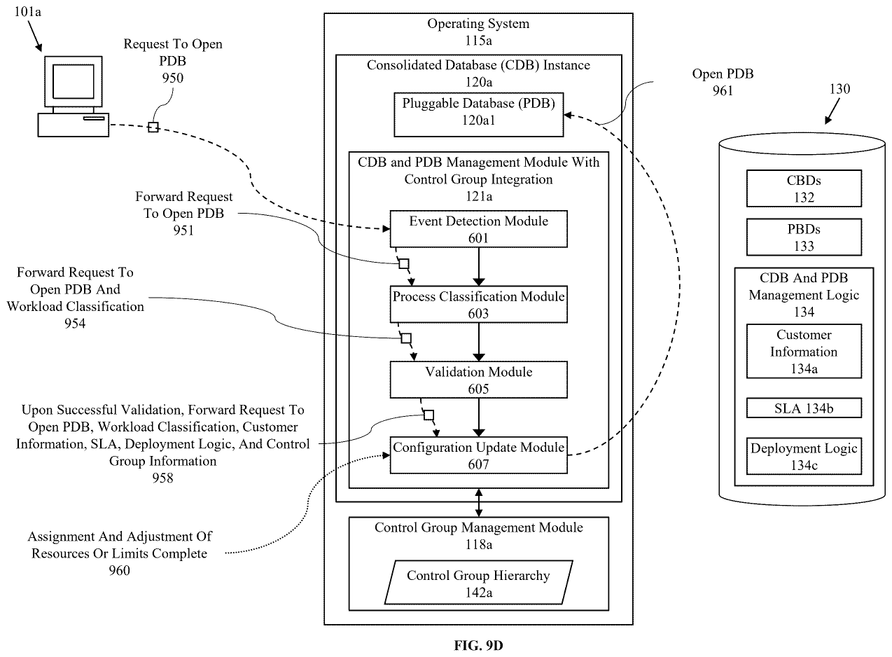

FIG. 9A-9D provide an example flow for processing a configuration change event comprising a PDB open operation according to some embodiments. As provided herein, this example flow is illustrated with regard to at least some portions previously illustrated in FIG. 1 and FIG. 6. Where elements are identified by like reference numbers, the descriptions provided elsewhere in regard to those elements is applicable to the example illustrated here.

FIG. 9A illustrates the present example, where an open PDB request is received at 950 from a computing device 101a.

As illustrated, that request is routed to the CDB and PDB management module with control group integration 121a and identified by the event detection module 601 which subsequently forwards the request to open the PDB to the process classification module 603 at 951.

As provided herein, in some embodiments, the classification module fetches classification logic 952 from the CDB and PDB management logic 134. In some embodiments, the classification module 603 maintains the classification logic internally—e.g., in a volatile storage associated with the module. For instance, here, the classification module, at 953, identifies a level within the hierarch to place the workload and a parent classification for that workload (e.g., parent is a representation of a CDB instance in the control group hierarchy).

Once the classification is determined the process classification module forwards the request to open the PDB and workload classification to the validation module 605 at 954.

FIG. 9B continues the flow illustrated in FIG. 9A, where the open PDB request was just forwarded to the validation module 605 at 954.

As illustrated, the validation module 605 first performs required data collection operations. Specifically, the validation module fetches the customer information from 134a, SLA from 134b, and deployment logic 134c. Additionally, the validation module recursively validates corresponding control groups as discussed herein to determine whether allocation of resources to open the PDB request can be completed without violating any allocation rules at 957. As part of this process, one or any number of requests to the control group hierarchy to retrieve relevant information may be executed—e.g., a fetch operating might be initiate for each group and subgroup to verify that necessary resources are available.

Finally, after the recursive processing has completed by the validation module, assuming that no violations were identified, the process upon successful validation, forwards the request to the open PDB, workload classification, customer information, SLA, deployment logic, and control group information at 958 to the configuration update module 607.

FIG. 9C continues the flow illustrated in FIG. 9B, where the open PDB request along with other information was just forwarded to the configuration update module 607 at 958.

As illustrated, the validation module 605 forwards the request to the open PDB, workload classification, customer information, SLA, deployment logic, and control group information at 958 to the configuration update module 607. However, in other embodiments, the configuration update module might need to fetch one or more of the customer information, SLA, deployment logic, and control group information. Regardless of how the configuration update module 607 gets access to the indicated information the configuration update module will recursively determine, assign, and adjust resources or limits at corresponding control groups at 959. This might be accomplished in any way as discussed herein. For instance, the configuration update module might directly access the control group hierarchy and perform one or more read and write operations to fetch and update the allocations there.

FIG. 9D continues the flow illustrated in FIG. 9C, where the resource allocations or limits for corresponding control groups were determined, assigned, and adjusted at 959. In FIG. 9D, after completion of the assignment and adjustment of resources or limits complete at 960, the requested PDB can be open. For instance, the PDB may be opened at 961. The resources allocated to that PDB now being specified by the corresponding control group in the control group hierarch.

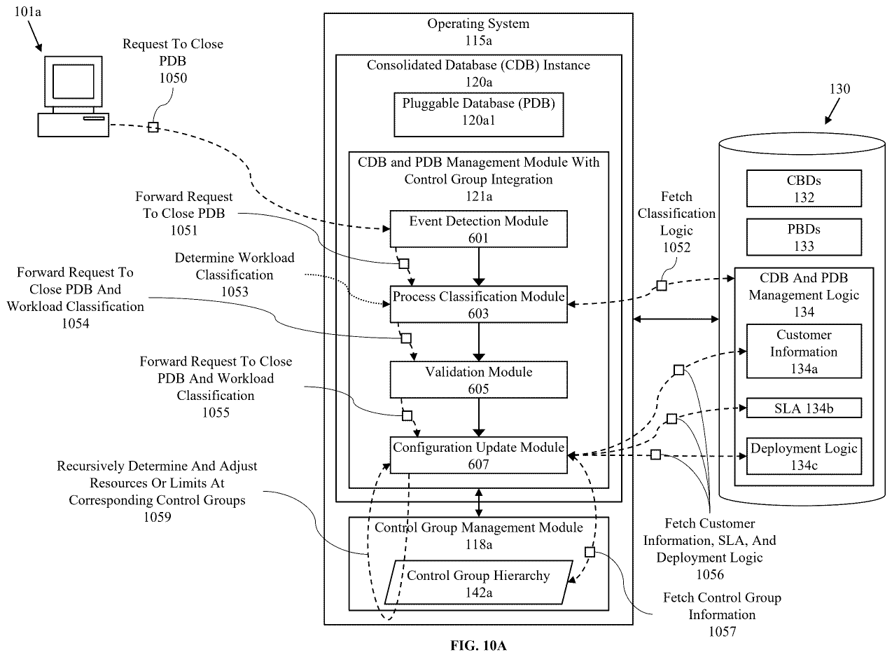

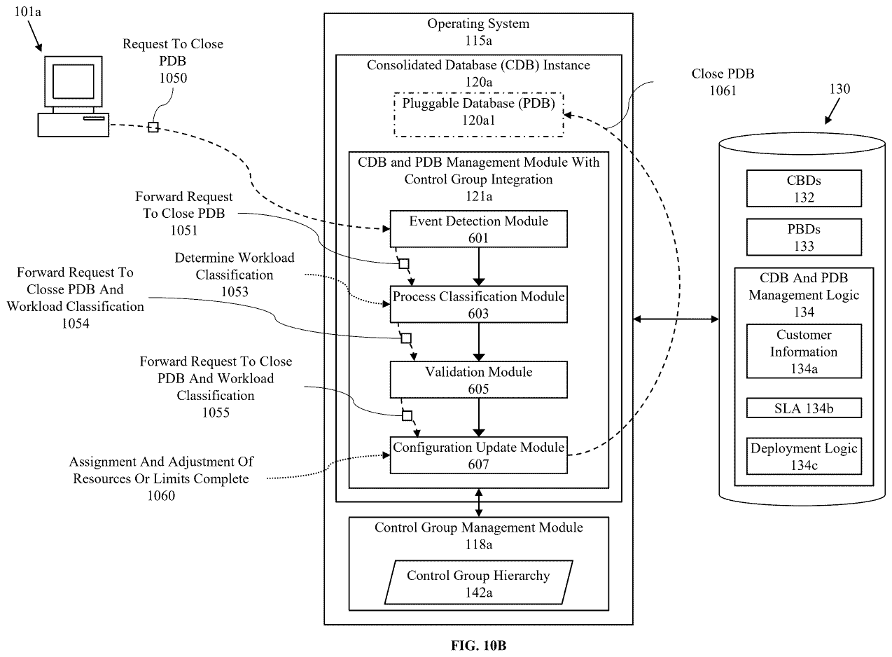

FIG. 10A-10B provide an example flow for processing a configuration change event comprising a PDB close operation according to some embodiments. As provided herein, this example flow is illustrated with regard to at least some portions previously illustrated in FIG. 1 and FIG. 6. Where elements are identified by like reference numbers, the descriptions provided elsewhere in regard to those elements is applicable to the example illustrated here.

FIG. 10A illustrates the present example, where a close PDB request is received at 1050 from a computing device 101a.

As illustrated, that request is routed to the CDB and PDB management module with control group integration 121a and identified by the event detection module 601 which subsequently forwards the request to close the PDB to the process classification module 603 at 1051.

As provided herein, in some embodiments, the classification module fetches classification logic 1052 from the CDB and PDB management logic 134. In some embodiments, the classification module 603 maintains the classification logic internally—e.g., in a volatile storage associated with the module. For instance, here, the classification module, at 1053, identifies a level within the hierarch where the workload would have been placed and a parent classification for that workload (e.g., parent is a representation of a CDB instance in the control group hierarchy).

Once the classification is determined the process classification module forwards the request to close the PDB and workload classification to the validation module 605 at 1054. However, in contrast to the example in FIGS. 9A-D, the validation module only can either be bypassed or can be used to determine that validation is passed as the request will release resource without requiring a further allocation.

After the validation module has completed processing, the process forwards the request to the close the PDB, workload classification and control group information at 1055 to the configuration update module 607. Here, the configuration update module fetches one or more of the customer information, SLA, deployment logic, and control group information (see e.g., 1056 and 1057). Using the fetched information, the configuration update module will recursively determine, assign, and adjust resources or limits at corresponding control groups at 1059. This might be accomplished in any way as discussed herein. For instance, the configuration update module might directly access the control group hierarchy and perform one or more read and write operations to fetch and update the allocations there.

FIG. 10B continues the flow illustrated in FIG. 10A, where the resource allocations or limits for corresponding control groups were determined, assigned, and adjusted at 1059. In FIG. 10B, after completion of the assignment and adjustment of resources or limits complete at 1060, the requested PDB can be close. For instance, the PDB may be closed at 1061. The resources allocated to that PDB are now available for allocation to another resource or already distributed to other workloads for the CDB instance as specified by the corresponding control group(s) in the control group hierarch.

### System Architecture

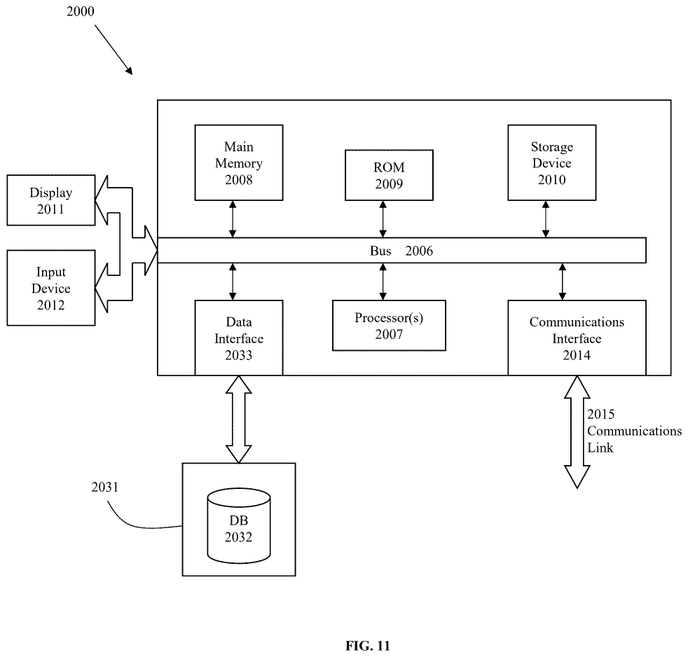

FIG. 11 is a block diagram of an illustrative computing system 2000 suitable for implementing an embodiment of the present invention. Computer system 2000 includes a bus 2006 or other communication mechanism for communicating information, which interconnects subsystems and devices, such as processor 2007, system memory 2008 (e.g., RAM), static storage device 2009 (e.g., ROM), disk drive 2010 (e.g., magnetic or optical), communication interface 2014 (e.g., modem or Ethernet card), display 2011 (e.g., CRT or LCD), input device 2012 (e.g., keyboard), and cursor control.

According to one embodiment of the invention, computer system 2000 performs specific operations by processor 2007 executing one or more sequences of one or more instructions contained in system memory 2008. Such instructions may be read into system memory 2008 from another computer readable/usable medium, such as static storage device 2009 or disk drive 2010. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 2007 for execution. Such a medium may take many forms, including but not limited to, non-volatile media and volatile media. Non-volatile media includes, for example, optical or magnetic disks, such as disk drive 2010. Volatile media includes dynamic memory, such as system memory 2008.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, cloud-based storage, or any other medium from which a computer can read.

In an embodiment of the invention, execution of the sequences of instructions to practice the invention is performed by a single computer system 2000. According to other embodiments of the invention, two or more computer systems 2000 coupled by communication link 2015 (e.g., LAN, PTSN, or wireless network) may perform the sequence of instructions required to practice the invention in coordination with one another.

Computer system 2000 may transmit and receive messages, data, and instructions, including program, i.e., application code, through communication link 2015 and communication interface 2014. Received program code may be executed by processor 2007 as it is received, and/or stored in disk drive 2010, or other non-volatile storage for later execution. Data may be accessed from a database 2032 that is maintained in a storage device 2031, which is accessed using data interface 2033.

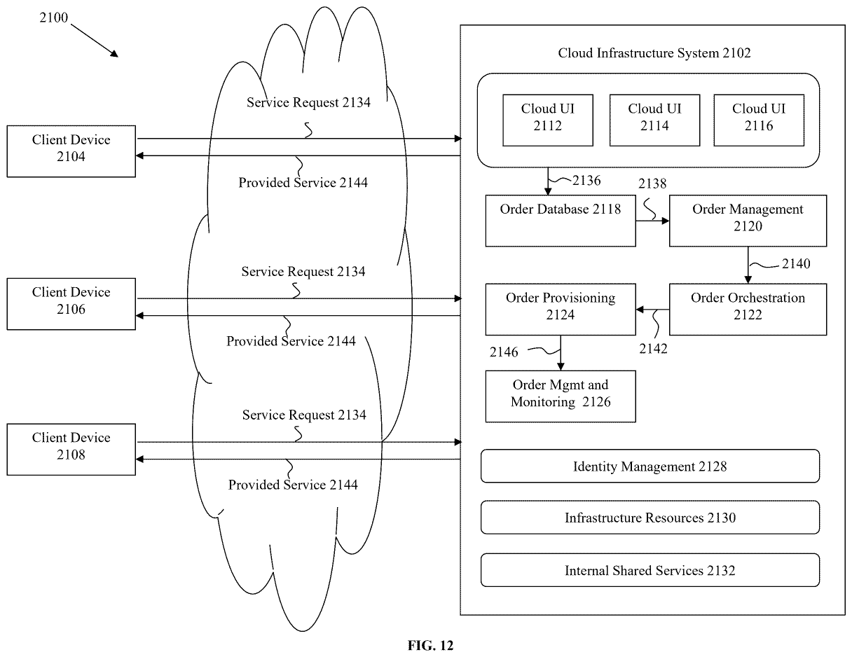

FIG. 12 is a simplified block diagram of one or more components of a system environment 2100 by which services provided by one or more components of an embodiment system may be offered as cloud services, in accordance with an embodiment of the present disclosure. In the illustrated embodiment, system environment 2100 includes one or more client computing devices 2104, 2106, and 2108 that may be used by users to interact with a cloud infrastructure system 2102 that provides cloud services. The client computing devices may be configured to operate a client application such as a web browser, a proprietary client application, or some other application, which may be used by a user of the client computing device to interact with cloud infrastructure system 2102 to use services provided by cloud infrastructure system 2102.

It should be appreciated that cloud infrastructure system 2102 depicted in the figure may have other components than those depicted. Further, the embodiment shown in the figure is only one example of a cloud infrastructure system that may incorporate an embodiment of the invention. In some other embodiments, cloud infrastructure system 2102 may have more or fewer components than shown in the figure, may combine two or more components, or may have a different configuration or arrangement of components.

Client computing devices 2104, 2106, and 2108 may be devices similar to those described above for FIG. 11. Although system environment 2100 is shown with three client computing devices, any number of client computing devices may be supported. Other devices such as devices with sensors, etc. may interact with cloud infrastructure system 2102.

Network(s) 2110 may facilitate communications and exchange of data between clients 2104, 2106, and 2108 and cloud infrastructure system 2102. Each network may be any type of network familiar to those skilled in the art that can support data communications using any of a variety of commercially available protocols. Cloud infrastructure system 2102 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 2102 may include a suite of applications, middleware, and database service offerings that are delivered to a customer in a self-service, subscription-based, elastically scalable, reliable, highly available, and secure manner.

In various embodiments, cloud infrastructure system 2102 may be adapted to automatically provision, manage and track a customer's subscription to services offered by cloud infrastructure system 2102. Cloud infrastructure system 2102 may provide the cloud services via different deployment models. For example, services may be provided under a public cloud model in which cloud infrastructure system 2102 is owned by an organization selling cloud services and the services are made available to the general public or different industry enterprises. As another example, services may be provided under a private cloud model in which cloud infrastructure system 2102 is operated solely for a single organization and may provide services for one or more entities within the organization. The cloud services may also be provided under a community cloud model in which cloud infrastructure system 2102 and the services provided by cloud infrastructure system 2102 are shared by several organizations in a related community. The cloud services may also be provided under a hybrid cloud model, which is a combination of two or more different models.

In some embodiments, the services provided by cloud infrastructure system 2102 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 2102. Cloud infrastructure system 2102 then performs processing to provide the services in the customer's subscription order.

In some embodiments, the services provided by cloud infrastructure system 2102 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 2102 may also include infrastructure resources 2130 for providing the resources used to provide various services to customers of the cloud infrastructure system. In one embodiment, infrastructure resources 2130 may include pre-integrated and optimized combinations of hardware, such as servers, storage, and networking resources to execute the services provided by the PaaS platform and the SaaS platform.

In some embodiments, resources in cloud infrastructure system 2102 may be shared by multiple users and dynamically re-allocated per demand. Additionally, resources may be allocated to users in different time zones. For example, cloud infrastructure system 2130 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 2132 may be provided that are shared by different components or modules of cloud infrastructure system 2102 and by the services provided by cloud infrastructure system 2102. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

In certain embodiments, cloud infrastructure system 2102 may provide comprehensive management of cloud services (e.g., SaaS, PaaS, and IaaS services) in the cloud infrastructure system. In one embodiment, cloud management functionality may include capabilities for provisioning, managing, and tracking a customer's subscription received by cloud infrastructure system 2102, and the like.

In one embodiment, as depicted in the figure, cloud management functionality may be provided by one or more modules, such as an order management module 2120, an order orchestration module 2122, an order provisioning module 2124, an order management and monitoring module 2126, and an identity management module 2128. These modules may include or be provided using one or more computers and/or servers, which may be general purpose computers, specialized server computers, server farms, server clusters, or any other appropriate arrangement and/or combination.

In operation 2134, a customer using a client device, such as client device 2104, 2106 or 2108, may interact with cloud infrastructure system 2102 by requesting one or more services provided by cloud infrastructure system 2102 and placing an order for a subscription for one or more services offered by cloud infrastructure system 2102. In certain embodiments, the customer may access a cloud User Interface (UI), cloud UI 2112, cloud UI 2114 and/or cloud UI 2116 and place a subscription order via these UIs. The order information received by cloud infrastructure system 2102 in response to the customer placing an order may include information identifying the customer and one or more services offered by the cloud infrastructure system 2102 that the customer intends to subscribe to.

After an order has been placed by the customer, the order information is received via the cloud UIs, 2112, 2114 and/or 2116. At operation 2136, the order is stored in order database 2118. Order database 2118 can be one of several databases operated by cloud infrastructure system 2118 and operated in conjunction with other system elements. At operation 2138, the order information is forwarded to an order management module 2120. In some instances, order management module 2120 may be configured to perform billing and accounting functions related to the order, such as verifying the order, and upon verification, booking the order. At operation 2140, information regarding the order is communicated to an order orchestration module 2122. Order orchestration module 2122 may utilize the order information to orchestrate the provisioning of services and resources for the order placed by the customer. In some instances, order orchestration module 2122 may orchestrate the provisioning of resources to support the subscribed services using the services of order provisioning module 2124.

In certain embodiments, order orchestration module 2122 enables the management of business processes associated with each order and applies business logic to determine whether an order should proceed to provisioning. At operation 2142, upon receiving an order for a new subscription, order orchestration module 2122 sends a request to order provisioning module 2124 to allocate resources and configure those resources needed to fulfill the subscription order. Order provisioning module 2124 enables the allocation of resources for the services ordered by the customer. Order provisioning module 2124 provides a level of abstraction between the cloud services provided by cloud infrastructure system 2102 and the physical implementation layer that is used to provision the resources for providing the requested services. Order orchestration module 2122 may thus be isolated from implementation details, such as whether or not services and resources are provisioned on the fly or pre-provisioned and only allocated/assigned upon request.

At operation 2144, once the services and resources are provisioned, a notification of the provided service may be sent to customers on client devices 2104, 2106 and/or 2108 by order provisioning module 2124 of cloud infrastructure system 2102.

At operation 2146, the customer's subscription order may be managed and tracked by an order management and monitoring module 2126. In some instances, order management and monitoring module 2126 may be configured to collect usage statistics for the services in the subscription order, such as the amount of storage used, the amount data transferred, the number of users, and the amount of system up time and system down time.

In certain embodiments, cloud infrastructure system 2102 may include an identity management module 2128. Identity management module 2128 may be configured to provide identity services, such as access management and authorization services in cloud infrastructure system 2102. In some embodiments, identity management module 2128 may control information about customers who wish to utilize the services provided by cloud infrastructure system 2102. Such information can include information that authenticates the identities of such customers and information that describes which actions those customers are authorized to perform relative to various system resources (e.g., files, directories, applications, communication ports, memory segments, etc.) Identity management module 2128 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

Additionally, the approach disclosed herein for a framework for hierarchically allocating resources and monitoring resource usage of cloud database runtime entities address at least some of the issues of prior techniques suffer from, by providing a mechanism where the a CDB instance, can manage the allocation of resources and metrics collection without largely creating duplicate processes for such. Instead, the present approach leverages the control group mechanism of an operating system upon which a database (CDB) instance executes, while allowing the database to manage the allocation of resources using a custom set of logic (e.g., logic corresponding to service level agreements).

What is claimed is:

1. A computer-implemented method comprising:
instantiating a database instance on an operating system having a control group hierarchy;
capturing an allocation of resources to the database instance in the control group hierarchy;
monitoring the database instance for configuration change events; and
processing, in response to detection of a configuration change event, a configuration change event base on at least resource allocations in the control group hierarchy and deployment logic.

2. The method of claim 1, wherein the database instance comprises a consolidated database (CDB) instance and the operating system periodically captures resource utilization metrics for processes represented in the control group hierarchy.

3. The method of claim 1, wherein the deployment logic includes rules that enforce an isolation requirement.

4. The method of claim 1, wherein a configuration change event corresponds to a start or end of a workload and the deployment logic includes rules that place workloads in respective consumer groups in the control group hierarchy.

5. The method of claim 1, wherein processing a configuration change event base on at least resource allocations in the control group hierarchy comprises:
classifying a workload corresponding to the configuration change event; and
validating a change to the control group hierarchy corresponding to the workload.

6. The method of claim 5, wherein validating a change to the control group hierarchy corresponding to the workload comprises processing a location of a group in the control group hierarchy corresponding to the configuration change event and recursively processing a plurality of subgroups in the control group hierarchy to determine whether resources can be allocated to the workload without violating any minimum allocation rules corresponding to the group or subgroups.

7. The method of claim 5, wherein processing a configuration change event base on at least resource allocations in the control group hierarchy further comprises assigning resources or limits on resource consumption to the workload based on an allocation rule.

8. The method of claim 7, wherein processing a configuration change event base on at least resource allocations in the control group hierarchy further comprises:
modifying resource assignments or limits on resource consumption of other workloads represented in the control group hierarchy based on the same or a different allocation rule; and
recursively processing a plurality of subgroups in the control group hierarchy to update resource assignments or limits on resource consumption of one or more workloads represented in individual ones of the plurality of subgroups.

9. A non-transitory computer readable medium having stored thereon a sequence of instructions which, when executed by a processor causes a set of acts comprising:
instantiating a database instance on an operating system having a control group hierarchy;
capturing an allocation of resources to the database instance in the control group hierarchy;
monitoring the database instance for configuration change events; and
processing, in response to detection of a configuration change event, a configuration change event base on at least resource allocations in the control group hierarchy and deployment logic.

10. The non-transitory computer readable medium of claim 9, wherein the database instance comprises a consolidated database (CDB) instance and the operating system periodically captures resource utilization metrics for processes represented in the control group hierarchy.

11. The non-transitory computer readable medium of claim 9, wherein the deployment logic includes rules that enforce an isolation requirement.

12. The non-transitory computer readable medium of claim 9, wherein a configuration change event corresponds to a start or end of a workload and the deployment logic includes rules that place workloads in respective consumer groups in the control group hierarchy.

13. The non-transitory computer readable medium of claim 9, wherein processing a configuration change event base on at least resource allocations in the control group hierarchy comprises:
classifying a workload corresponding to the configuration change event; and
validating a change to the control group hierarchy corresponding to the workload.

14. The non-transitory computer readable medium of claim 13, wherein validating a change to the control group hierarchy corresponding to the workload comprises processing a location of a group in the control group hierarchy corresponding to the configuration change event and recursively processing a plurality of subgroups in the control group hierarchy to determine whether resources can be allocated to the workload without violating any minimum allocation rules corresponding to the group or subgroups.

15. The non-transitory computer readable medium of claim 13, wherein processing a configuration change event base on at least resource allocations in the control group hierarchy further comprises assigning resources or limits on resource consumption to the workload based on an allocation rule.

16. The non-transitory computer readable medium of claim 15, wherein processing a configuration change event base on at least resource allocations in the control group hierarchy further comprises:
modifying resource assignments or limits on resource consumption of other workloads represented in the control group hierarchy based on the same or a different allocation rule; and
recursively processing a plurality of subgroups in the control group hierarchy to update resource assignments or limits on resource consumption of one or more workloads represented in individual ones of the plurality of subgroups.

17. A computing system comprising:
a memory to hold a set of instructions;
a computer processor to execute the set of instructions, which when executed cause a set of acts comprising:
instantiating a database instance on an operating system having a control group hierarchy;
capturing an allocation of resources to the database instance in the control group hierarchy;
monitoring the database instance for configuration change events; and
processing, in response to detection of a configuration change event, a configuration change event base on at least resource allocations in the control group hierarchy and deployment logic.

18. The computer system of claim 17, wherein the database instance comprises a consolidated database (CDB) instance and the operating system periodically captures resource utilization metrics for processes represented in the control group hierarchy.

19. The computer system of claim 17, wherein the deployment logic includes rules that enforce an isolation requirement.

20. The computer system of claim 17, wherein a configuration change event corresponds to a start or end of a workload and the deployment logic includes rules that place workloads in respective consumer groups in the control group hierarchy.
